(19) United States
(12) Patent Application Publication
(10) Pub. No.: US 2014/0081994 A1
(43) Pub. Date: Mar. 20, 2014

(54) Identifying Content for Planned Events Across Social Media Sites

(71) Applicant: RUTGERS, THE STATE OF UNIVERSITY OF NEW JERSEY, New Brunswick, NJ (US)

(72) Inventors: Hila Becker, New York, NY (US); Mor Naaman, New York, NY (US); Luis Gravano, New York, NY (US)

(73) Assignee: THE TRUSTEES OF COLUMBIA UNIVERSITY IN THE CITY OF NEW YORK, New York, NY (US)

(21) Appl. No.: 13/963,685

(22) Filed: Aug. 9, 2013

Related U.S. Application Data
(60) Provisional application No. 61/681,816, filed on Aug. 10, 2012.

(51) Int. Cl. G06F 17/30

(52) U.S. Cl. CPC G06F 17/30389
USPC 707/749; 707/765

(57) ABSTRACT

A method of retrieving content from one or more media content sites may include identifying one or more event features corresponding to an event, automatically generating, by a computing device, a first set of one or more queries based on the identified event features, running, by the computing device, at least a portion of the first set of queries against one or more media content sites to generate a first content dataset comprising one or more media documents that satisfy the queries, creating a query model for each query based on one or more results retrieved for the query in the first content dataset, evaluating each query model against one or more of the identified event features to identify a match, and performing one or more of the following: filtering the queries based on their associated match, and ranking the queries based on their associated match.

### RELATED APPLICATIONS AND CLAIM OF PRIORITY

This application claims priority to U.S. Provisional Patent Application No. 61/681,816, titled “Identifying Content for Real-World Events Using Multiple-Query and Model-Driven Strategies” filed Aug. 10, 2012, which is incorporated herein by reference in its entirety.

### GOVERNMENT RIGHTS

The work described herein was funded, in whole or in part, by grant numbers IIS-0811038, IIS-1017845 and IIS-1017389 from the National Science Foundation. The United States Government has certain rights in the invention.

### BACKGROUND

Event-based information sharing and seeking are common user interaction scenarios on the Web today. The bulk of information about and from events is often contributed by individuals through media channels such as on photo and video-sharing sites (e.g., Flickr, YouTube), as well as on social networking sites (e.g., Facebook, Twitter). This event-related information can appear in many forms, including through status updates in anticipation of an event, photos and videos captured before, during, and after the event, and messages containing post-event reflections.

For example, a user may be interested in the “Celebrate Brooklyn!” festival, an arts festival that happens in Brooklyn, N.Y. every summer. This user could obtain general information about the various music performances during this year's “Celebrate Brooklyn!” using Last.fm, a popular site that contains information about music events. However, a user cannot see media items shared by other users on the site. Last.fm offers useful details about concerts at “Celebrate Brooklyn!,” including the time/date, location, title, and description of these concerts. However, since Last.fm only provides basic event information, the user may consider exploring a variety of complementary sites (e.g., Twitter, YouTube) to augment this information with actual media content.

Automatically identifying media content associated with known events may be challenging due to the heterogeneous and noisy nature of the data. These properties may present a double challenge where both the known event information and its associated media content tend to exhibit missing or ambiguous information, and include short, ungrammatical textual features. In the “Celebrate Brooklyn!” example, event features (e.g., title, description, location) may be supplied by a system user. Therefore, these features may consist of generic titles (e.g., “Opening Night Concert”), missing descriptions, or insufficient venue information (e.g., “Prospect Park,” with no exact address). Similarly, media content associated with this event may be ambiguous (e.g., a YouTube video titled “Bird singing at the opening night gala”) or not have a clear connection to the event (e.g., a tweet stating “#CB! starts next week, very excited!”).

Existing approaches to find and organize media content associated with known events are limited in the amount and types of event content that they can handle. Most related research relies on known event content in the form of manually selected terms (e.g., “earthquake,” “shaking” for an earthquake) to describe an event. These terms are often used to identify social media documents, with the assumption that documents containing these select terms will also contain information about the event. Unfortunately, manually selecting terms for an event is not a scalable approach. A recent effort described by E. Benson, A. Haghighi, and R. Barzilay in “Event discovery in social media feeds” in Proceedings of the 49^{th} Annual Meeting of the Association for Computational Linguistics: Human Language Technologies (ACL-HLT '11), 2011, used graphical models to label artist and venue terms in Twitter messages, identifying a set of related Twitter messages for concert events. While this work goes a step further in automating the process of associating events with social media documents, it is still tailored to a particular type of event (i.e., concerts) and restricted to a subset of the associated social media documents (i.e., documents containing venue and artist terms). These related efforts focus on identifying site-specific event content, often tailoring their approaches to a particular site and its properties.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of retrieving content from one or more media content sites may include identifying one or more event features corresponding to an event, automatically generating, by a computing device, a first set of one or more queries based on the identified event features, running, by the computing device, at least a portion of the first set of queries against one or more media content sites to generate a first content dataset comprising one or more media documents that satisfy the queries, creating a query model for each query based on one or more results retrieved for the query in the first content dataset, evaluating each query model against one or more of the identified event features to identify a match, and performing one or more of the following: filtering the queries based on their associated match, and ranking the queries based on their associated match.

In an embodiment, a system for retrieving content from one or more social media sites may include a computing device and a computer-readable storage medium in communication with the computing device. The computer-readable storage medium may include one or more programming instructions that, when executed, cause the computing device to identify one or more event features corresponding to an event, develop a first set of one or more precision-oriented queries based on the identified event features, run the first set of precision-oriented queries against a first set of one or more media content sites to produce a first content dataset that comprises content from the first set of media content sites that satisfies the first set of precision-oriented queries, and refine the first set of precision-oriented queries to create a first subset of precision-oriented queries that comprises one or more precision-oriented queries whose results satisfy one or more parameters associated with the event.

### BRIEF DESCRIPTION OF THE DRAWINGS

FIG. 1 illustrates an example of an event record from a platform according to an embodiment.

FIG. 2 illustrates an example overview of a query generation approach according to an embodiment.

FIG. 3 illustrates an example document volume histogram according to an embodiment.

FIG. 4 illustrates a flow chart of an example method of retrieving content associated with an event from one or more media content sites according to an embodiment.

FIG. 5 illustrates a block diagram of an example system of retrieving content associated with an event from one or more media content sites according to an embodiment.

FIG. 6 illustrates a block diagram of example computer hardware that may be used to contain or implement program instructions according to an embodiment.

### DETAILED DESCRIPTION

User-contributed Web data may contain rich and diverse information about a variety of events in the physical world, such as shows, festivals, conferences and the like. This information may range from known event features (e.g., title, time, location) posted on event aggregation platforms (e.g., Last.fm events, EventBrite, Facebook events) to discussions and reactions related to events shared on different media content sites, such as, for example, social media sites.

In an embodiment, event aggregation platforms may refer to electronic technologies, such as websites for example, that may provide information about one or more events. Examples of event aggregation platforms may include, without limitation, Eventbrite, Meetup, Ticketfly, Livenation, Splashthat. Delicious, Bitly, Last.fm, Setlist.fm. Echonest, Soundcloud, Pandora, Songza and/or Spotify.

In an embodiment, a media content site, service and/or technology may refer to web-based and/or mobile-based technologies, such as, for example, websites and data feeds, that include information pertaining to one or more events. In an embodiment, an example of a media content site may be a social media site. A social media site may be a site, service and/or technology that may be used to facilitate dialogue among individuals and/or groups. In an embodiment, another example of a media content site may be one or more news sites, blogs, and/or the like. Examples of media content sites may include, without limitation. Twitter, YouTube, Flickr, LinkedIn, Facebook, Instagram, Tumblr, Picasa, and Google+, FourSquare, Tumblr, Yammer, app.net, Vimeo, Viddy, Social Cam, Livestream, 500 Pixels, lmgur, Twitpic, vfrog, Photobucket, Smugmug, Snapfish, NBC, CBS, ABC, ESPN, Viacom, Fox, CNN, the New York Times, the Associated Press, Reuters, Bloomberg, Huffington Post, Digg, Reddit, Getty Images, Corbis, Wikipedia, Wikia and/or the like.

Although social media sites are discussed as examples throughout this disclosure, it is understood that other media content sites may be used within the scope of this disclosure.

In an embodiment, a media content site may include a dedicated database and/or data repository that stores media content. The stored media content may be collected and/or obtained in advance of running a query.

In an embodiment, content pertaining to an event may be identified for events across different media content sites. Information about an event may be provided from users, such as, for example, website administrators or editors, or an event aggregation platform may be used to identify event information. Event aggregation platforms may be mined to extract one or more event features, which are often noisy or missing. The features may be used to develop query formulation strategies for retrieving content associated with an event on different media content sites. Further, event content identified on one media content site may be used to retrieve additional relevant event content on other media content sites. The strategies may be applied to a large set of user-contributed events, and their effectiveness in retrieving relevant event content from media content sites, such as, for example, Twitter, YouTube, and Flickr, may be analyzed. Automatically identifying and associating media content with events may greatly enhance a user's event-based information seeking experience.

In an embodiment, event features such as an event title (e.g., “Celebrate Brooklyn! Opening Gala”), description (e.g., “Singer/songwriter Andrew Bird will open the 2011 Celebrate Brooklyn! season”), time/date (e.g., Jun. 10, 2011), location (e.g., Brooklyn, N.Y.), and venue (e.g., “Prospect Park”) may be leveraged to automatically formulate one or more queries that may be used to retrieve related media content from one or more media content sites. In an embodiment, queries may be generated according to a two-step approach. The first step may combine known event features into one or more queries aimed at retrieving high-precision results. The second step may use these high-precision results along with text processing techniques, such as, for example, term extraction and frequency analysis, to build models that generate additional queries aimed at improving recall. In an embodiment, the second step may be optional. In an embodiment, queries may be formulated for each media content site individually. In an embodiment, retrieved content from one site may be used to improve the retrieval process on another site.

In an embodiment, an event may refer to a real-world occurrence, e, with (1) an associated time period Te, and (2) a time-ordered stream of media content documents, De, that discuss the occurrence of e and that are published during time Te. In an embodiment, an event may refer to any record posted to a public event planning and aggregation platform available on the Web, for example and without limitation, Last.fm or EventBrite, or an event created by a user on a dedicated service or website.

Regardless of the platform on which they are posted, user-contributed event records generally share a core set of one or more event features that describe the event along different dimensions. These features may include: (i) the title or the name of the event (e.g., “Celebrate Brooklyn! Opening Night Gala & Concert with Andrew Bird”); (ii) a description of the event, such as a paragraph outlining specific event details (e.g., “ . . . Celebrate Brooklyn! Prospect Park Bandshell FREE Rain or Shine”); (iii) a time and/or date of the event (e.g., Friday 10 Jun. 2011); (iv) a venue at which the event is being held (e.g., Prospect Park); and/or (v) a location of the event, such as the address of the event (e.g., Brooklyn, N.Y.). These event features, collectively, may be helpful for constructing queries that can retrieve different types of media documents associated with the event.

In an embodiment, an event may be a planned event, such as a concert, a parade, a festival and/or the like. In an alternate embodiment, an event may be an unplanned event, such as, for example, a natural disaster, a sports victory and/or the like.

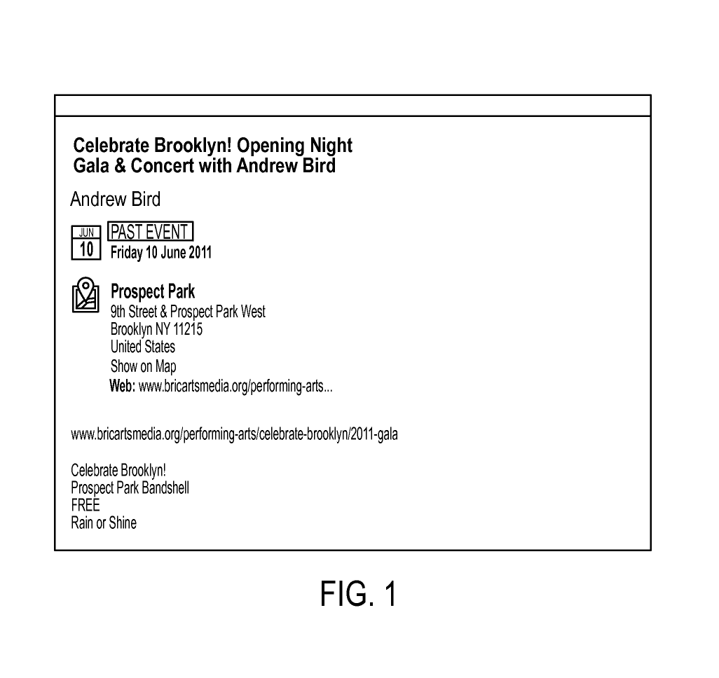

In an embodiment, an event may be identified by a user of a system who desires to obtain information about the event from one or more media content sites. For example, a user may provide the system with one or more features associated with the event, such as the title of the event or the location of the event. In an embodiment, an event may be identified from one or more platforms, such as, for example, Last.fm, EventBrite, and Facebook. Platforms may describe one or more features of an event. As such, one or more event features associated with an event may be identified from one or more platforms. FIG. 1 illustrates an example of an event record from a platform according to an embodiment. In an embodiment, an event record may be created for a past, future or ongoing event by a system for retrieving content associated with an event from one or more media content sites such as, for example, the system illustrated in FIG. 9.

In an embodiment, a media document may be relevant to an event if it provides a reflection on the event before, during, and/or after the event occurs. A media document may be information available from a media content site such as, for example, text, a photograph, a video, a tweet, a status update, a message, a hyperlink, a comment, a news report, a blog post and/or the like.

For instance, referring back to the “Celebrate Brooklyn!” opening gala concert example, related media documents may reflect anticipation of the event (e.g., a tweet stating “I'm so excited for this year's Celebrate Brooklyn! and the FREE opening concert!”), participation in the event (e.g., a video of Andrew Bird singing at the opening gala), and post-event reflections (e.g., a photo of Prospect Park after the concert titled “Andrew Bird really knows how to put on a show”). These media documents may be relevant to a user seeking information about this event at different times.

In an embodiment, one or more relevant media documents may be retrieved for an event from one or more media content sites. The top-k such documents from each site may be identified according to site-specific scoring functions. Associating media documents with events may be defined as a query generation and retrieval task. Query generation strategies may be designed using event features as discussed above. For each event, a variety of queries may be generated, which may be used collectively to retrieve matching media documents from one or more media content sites. Since each event may potentially have many associated media documents, the set of media documents presented to a user may be filtered to the top-k most relevant media documents, using given site-specific scoring functions. For example, a multi-feature function, such as that described in more detail by H. Becker, M. Naaman and L. Gravano in “Learning similarity metrics for event identification in social media” in Proceedings of the Third ACM International Conference on Web Search and Data Mining (WSDM '10), 2010, may be used. Relevance metrics may differ across media content sites, since sites vary in their event features. For example, documents from Flickr and YouTube may have titles and descriptions whereas media documents from Twitter do not).

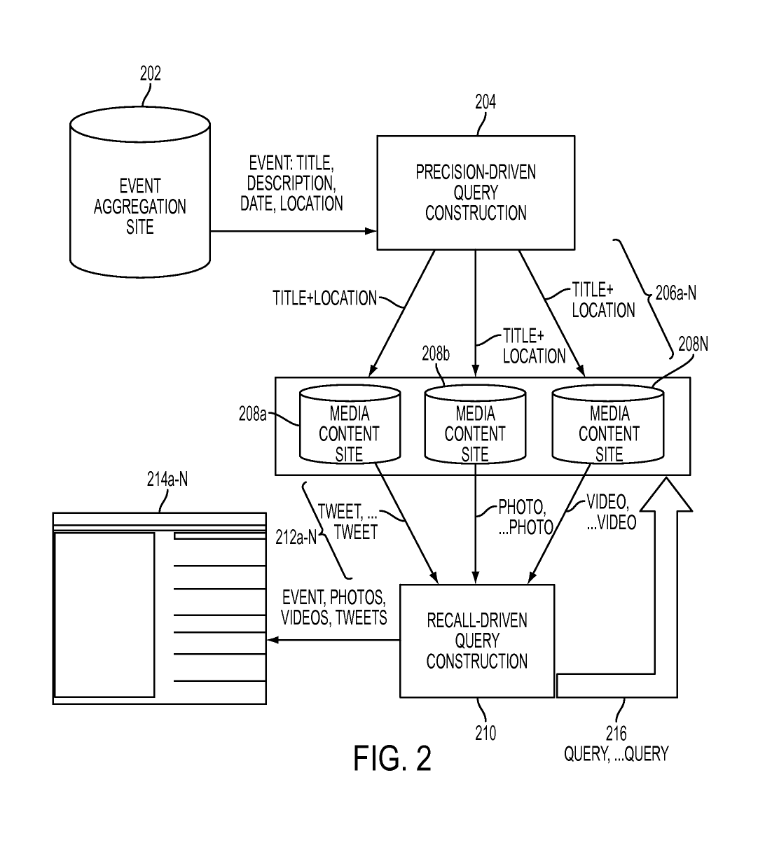

FIG. 2 illustrates an example overview of a query generation approach according to an embodiment. As illustrated by FIG. 2, one or more precision-oriented queries for an event may be defined using one or more event features. In an embodiment, one or more event features may be retrieved from an event aggregation site 202. The one or more event features may be retrieved by a query construction module 204 of a computing device. The query construction module 204 may send at least a portion of the event features 206a-N to one or more media content sites 208a-N. In an embodiment, a recall-driven query construction module 210 may receive one or more precision-oriented queries 212a-N, and may retrieve one or more media documents 214a-N with high-precision results. In an embodiment, to improve recall, term extraction and frequency analysis techniques may be used on the high-precision results to generate 216 recall-oriented queries and retrieve additional documents for the event.

### Precision-Oriented Query Building Strategies

In an embodiment, query generation strategies that are aimed at achieving high-precision results may be utilized. These strategies may form queries that touch on various aspects of an event (e.g., time/date and venue). In an embodiment, these queries may result in documents that relate to the intended event. A variety of query generation strategies may be considered. These strategies may involve different combinations of event features, such as, for example, title, time/date, and location, of each event.

The precision-oriented queries for an event may include combinations of one or more event features. One feature that may be included in the strategies is a restriction on the time at which the retrieved media content documents are posted. In an embodiment, the time period, Te, that is associated with an event may be set to start a day prior to the event's start time/date and to end a day after the event's end time/date. Additional and/or alternate time periods may be used within the scope of this disclosure.

In an embodiment, media documents that contain digital media items (e.g., photos, videos), may be considered if their associated media item was created during or after the event's start time. This may improve precision since many digital media items associated with an event may be unlikely to be captured prior to the start of the event. In an alternate embodiment, media documents that contain digital media items that were created before an event's start time may be considered.

In an embodiment, a location, Le, associated with an event may be defined as the geographical name of the event place, or the venue, or exact geographic coordinates, or a geographic bounding box, or a coordinates and radius. In an embodiment, media documents that contain digital media items (e.g., photos, videos), may be considered if the associated media item was captured in the location defined for the event. This may improve precision since digital media items associated with the event location are more likely to be correct matches for the event. In an alternate embodiment, media documents that contain digital media items that were in an area larger than the defined event location may be retrieved.

In an embodiment, the title of an event may be included in the precision-oriented strategies. An event title may provide a precise notion of the subject of the event. Title values may exhibit substantial variations in specificity across event records. For example, some event titles might be too specific (e.g., “Celebrate Brooklyn!Opening Night Gala & Concert with Andrew Bird”). For any such specific title, any media documents matching it exactly will likely be relevant to the corresponding event. If the titles are too specific, however, no matching documents might be available, which motivates the recall-oriented techniques described below.

In contrast, other event titles might be too general (e.g., “Opening Night Concert”). To automatically accommodate these variations in title values, different query generation options may be considered for the title feature. Specifically, queries with the original title as a phrase may be generated to capture content for events with detailed titles. In an embodiment, queries with the original title as a phrase augmented with the event location may be considered to capture content for events with broad titles, for which the location helps narrow down the matching documents. In an embodiment, alternative query generation techniques that include the title keywords as a list of terms—rather than as a phrase—may be considered for flexibility, as well as variations of the non-phrase version that eliminate stop words from the queries. In an embodiment, a subset of terms and/or phrases that appear in the title and/or description may be considered.

In an embodiment, the system may have an interface that allows a user to select among different retrieval strategies. An example of a final set of selected precision-oriented textbased strategies is listed in Table 1. In an embodiment, query information may also include time, location, or other restrictions on the retrieved data based on the event information. For example, a query to photo sharing site Flickr may use text, location, and time information, as well as other event information. An example Flickr query that includes text and location based on the first row on Table 1 is: http://api.flickr.com/services/rest?method=flickr.photos.search&api_key=b993c5230b06f65bca6e1c6ea6732175&text=Celebrate+Brooklyn++Opening+Night+Gala+Concert+with+Andrew+Bird+Brooklyn&min_taken_date=aug+8+2011&max_taken_date=aug+10+2011&format:=rest

The retrieved documents for an event may be ranked and the system may only consider the top K documents according to the ranking. In an embodiment, the ranking may be determined by computing the similarity to the event record using (an adaptation of) the multiple-feature similarity function described by at least H. Becker, M. Naaman and L. Gravano in “Learning similarity metrics for event identification in social media” in Proceedings of the Third ACM International Conference on Web Search and Data Mining (WSDM '10), 2010.

As one additional component of the similarity, consider the percentage of queries that retrieve a given document were considered in the computation of the score for the document and an event. Documents that are retrieved by several of the queries for an event may be preferred over documents that are retrieved by one such query.

In an embodiment, the results retrieved by a query to a media site may be further filtered or ranked by the system to match the results to the event information. For example, a media site, such as, for example YouTube, may not allow a system to issue a query with location or time data. As such, a query may be issued that has a format as follows: https://gdata.youtube.com/feeds/api/videos?q=Celebrate%20Brooklyn!%20%20Opening%20Night%20Gala%20%26%20Concert%20with%20And rew%20Bird%20Brooklyn&orderby=rating&max-results=50&v=2&alt=jsonc. A system may review the results and keep only those that match the event location, the event time, and/or other event information.

In an embodiment, a system may obtain information from a media content site in other ways, and may store the information in a dedicated database. For example, a media content site such as Twitter may allow a system to “stream” data from the site using specific keywords (e.g. “celebratebrooklyn”). In another example, a media content site such as the New York Times site may be crawled by a Web Crawler and information may be downloaded to a database server without reference to a specific event. In an embodiment, a system may stream, crawl or obtain data from such media services before the occurrence of an event. In an embodiment, such crawl or stream may be defined based on some specific event information such as, for example, a Twitter hashtag or keywords. In an embodiment, the system's queries may be issued against the local data repository instead of the media content site.

In an embodiment, queries may be ranked and selected based on an analysis of the results retrieved. A match of the retrieved content model to the event information may be determined as described below under the heading “Model Profile Match” for recall-based queries. In an embodiment, only data from queries that rank high on event match may be considered.

TABLE 1

| Strategy | Example |
|---|---|
| [“title” + “city”] | [“Celebrate Brooklyn! Opening Night Gala & |
| | Concert with Andrew Bird” “Brooklyn”] |
| [title + “city”] | [Celebrate Brooklyn! Opening Night Gala & |
| | Concert with Andrew Bird “Brooklyn”] |
| [title − stopwords + | [Celebrate Brooklyn! Opening Night Gala |
| “city”] | Concert Andrew Bird “Brooklyn”] |
| [“title” + “venue”] | [“Celebrate Brooklyn! Opening Night Gala & |
| | Concert with Andrew Bird” “Prospect Park”] |
| [title + “venue”] | [Celebrate Brooklyn! Opening Night Gala & |
| | Concert with Andrew Bird “Prospect Park”] |
| [“title”] | [“Celebrate Brooklyn! Opening Night Gala & |
| | Concert with Andrew Bird”] |
| [title] | [Celebrate Brooklyn! Opening Night Gala & |
| | Concert with Andrew Bird] |
| [title − unique phrases] | [Celebrate Brooklyn! Andrew Bird] |
| [title − unique phrases + | [Celebrate Brooklyn! Andrew Bird |
| “location”] | “Brooklyn”] |
| [title − quoted phrases + | [“Celebrate Brooklyn!” “Andrew Bird” |
| “location”] | “Brooklyn”] |
| [title − without | [Celebrate Brooklyn! Opening Night Gala |
| stopwords] | Concert Andrew Bird] |
| Venue | Media directly associated with a given venue |
| Location | Media within a radius, r, from a location |

### Recall-Oriented Query Building Strategies

While precision-oriented strategies may return high-precision media documents for an event, the number of these high-precision documents may be generally low. To improve recall, strategies for constructing queries using term-frequency analysis may be used. In an embodiment, an event's title, description, and any retrieved results from the precision-oriented techniques may be used as “ground-truth” data for the event. Precision-oriented results from each media content site may be considered individually, and also from all media content sites collectively. For example, the queries above may result in 1,000 items from one or more media content sites which may include: 320 tweets, 200 videos, 100 Facebook photos, 200 news stories and 80 Facebook statuses. This dataset may be considered as the “Ground truth” dataset.

The ground-truth data for each event may be used to design query formulation techniques to capture terms that uniquely identify each event. These terms may ideally appear in any media document associated with the event but also be broad enough to match a larger set of media documents than possible with the precision-oriented queries. These recall-oriented queries may be selected in two steps. First, a large set of candidate queries may be generated for each event using two or more different term analysis and extraction techniques. Then, to select the most promising queries out of a potentially large set of candidates, a variety of query ranking strategies may be considered, and the top queries according to each strategy may be identified.

Frequency Analysis:

The first query candidate generation technique aims to extract the most frequently used terms, while reducing the weight of terms that are naturally common in the English language. The idea is based on the traditional term-frequency, inverse-document-frequency approach used in information retrieval. To select these terms, term frequencies may be computed over the ground-truth data for word unigrams, bigrams, and trigrams. Stop words may be eliminated, and infrequent n-gram which may be (determined automatically based on the size of the ground-truth corpus, may be removed. In an embodiment, one or more frequently-used words may be removed. A frequently-used word may be a word that is too general to describe any event. For example, a word may be considered a frequently-used word if it appears in the top 10,000 most frequent words indexed by a search engine as of a certain date. Additional and/or alternate techniques for determining frequently-used words may be used within the scope of this disclosure.

To normalize the n-gram term frequency scores, a language model built from a large corpus of Web documents may be used. With this language model, log probability values may be computed for any candidate n-gram term. The probability of a term in the language model may provide an indication of its frequency on the Web and may be used to normalize the term's computed frequency. The n-grams extracted for each event may be sorted according to their normalized term frequency values, and a top 10 number of n-grams, such as the top 10 n-grams, may be selected as candidate queries for the event. For instance, referring to the Andrew Bird concert example, 100 documents may be retrieved, and the most frequent words or phrases in the documents may be:
(1) the (83)
(2) on (75)
(3) Andrew (55)
(4) Andrew Bird (30)
(5) Celebrate (25)
(6) CelebrateBkln (20)

On the Web, the terms “the”, “on”, “Andrew” and “celebrate”, may be common and may be discounted by the system. The terms “Andrew Bird” and “CelebrateBkln” may not be common and may be ranked highly by the system.

Term Extraction:

The second query candidate generation technique aims to identify meaningful event-related concepts in the ground-truth data using an external reference corpus. For this technique, a Web-based term extractor may be used over the available textual event data. The term extractor may leverage a large collection of Web documents, query logs to construct an entity dictionary, and use it along with statistical and linguistic analysis methodologies to find a list of significant terms. The extracted terms for each event may serve as additional recall-oriented query candidates, along with the term-frequency query candidates described above. For example, the Yahoo term extractor API, as described in http://developer.yahoo.com/search/content/V2/contentAnalysis.html, may be used to perform a term extraction from a given text. In another embodiment, a system may implement a term extraction algorithm using a dictionary of known entities such as company names, band names, and the like.

In an embodiment, the content retrieved from the various media sites may be used to extract special terms that may be used by users for an event that were not available from the event information. Such terms may include, for example, hashtags (such as those currently represented by a word with a ‘#’ prefix, on Twitter for example) that appear in the retrieved content. For example, a query for the Andrew Bird concert may retrieve many Twitter documents that contain the hashtags #andrewbird and #celebratebrkIn. For example, if 100 documents are retrieved, these hashtags may appear in 35 and 32 of the documents respectively. The hashtags may be used as queries for the second round of recall-oriented queries.

Each of the described techniques may potentially generate a large set of candidate queries. However, many of these queries may be noisy (e.g., [@birdfan], with the name of a user that posts many updates about the event), too general (e.g., [concert tonight]), or describing a specific or non-central aspect of the event (e.g., [Fitz and the Dizzyspells], the name of an Andrew Bird song from the concert). Issuing hundreds of queries for each event may not be scalable and may potentially introduce substantial noise. As such, the set of queries may be reduced to the most promising candidates. A variety of strategies for selecting the top candidate queries out of all possible queries may be used. Two criteria for ordering the event queries may be considered: specificity and model profile match.

Specificity:

Specificity may help to rank long, detailed queries higher than broad, general ones. Conjunctive query semantics may be used, and longer queries including multiple terms (e.g., [a,b]), may be more restrictive than shorter queries that include fewer terms (e.g., [a]). For example, if term n-gram shingles with n=1, 2, and 3 are used to construct the recall-oriented queries, the set of candidate queries may include bigram queries that are subsets of tri-gram queries (e.g., [bird concert] and [andrew bird concert]). If both such candidates are present in the set, the longer, more detailed version may be favored. This level of specificity may help improve precision and may not be restrictive enough to hurt recall.

Model Profile Match:

In an embodiment, the results of one or more queries may be modeled according to various features of the returned documents. For example, the results of one or more queries may be modeled according to timestamps, locations, terms used and the like. The model of the returned documents may be compared to the known event information to determine if there is a match. In an embodiment, the temporal profile of a query's results may be used to select among the candidate queries for an event. In an embodiment, the system may create a model of the retrieved documents using the creation time of retrieved documents. The model may compute an hourly volume of the retrieved documents. A spike in media document frequency around the known time of the event may serve as an indication that the query is indeed associated with the event. A record of the number of media documents retrieved by each query during the week before and the week after the event may be kept and compared to the query's media document volume during shorter time periods (e.g., one or two days) around the event's time span. In an embodiment, the spike may be detected based on a computation that considers the average and standard deviation of volume for the week before and after the event. A burst where the volume exceeds the average by more than one standard deviation may be identified. For sites containing digital media, the content creation time may be used as well as the content upload time, based on availability of the information.

In one embodiment, the spatial profile of a query's results may be used to select among the candidate queries for an event. In one embodiment, the system may create a model of the retrieved documents using the location information of retrieved documents. In an embodiment, the location may be represented by a latitude and longitude. In another embodiment, the location may be represented by a street address, a venue name, a venue identifier, or any other location specification. In an embodiment, the location may be associated with the user posting the document. The system may compute a spatial model of the retrieved documents, for example, frequency of documents by city, area, neighborhood, venue or a bounding box. A higher density of documents around the known location of the event may serve as an indication that the query is indeed associated with the event.

In an embodiment, the topical profile of a query's results may be used to select among the candidate queries for an event. In an embodiment, the system creates a model of the retrieved documents using the terms that appear in the content of the retrieved documents. In an embodiment, the terms included in the query may not be considered. The language model may compute a likelihood topic match between the retrieved terms and the event information. A match may be based on a simple topic classification. For example, if the top terms that are retrieved include the terms “hand”, “speakers”. “stage” and “guitar”, a classification algorithm may associate the content with a “music” topic. In an embodiment, a similar classification may be done on the event information and the results may be matched. In an embodiment, an event may have an associated content category assigned by a system or user. A good match between the terms in the retrieved documents to the event information topic may serve as an indication that the query is indeed associated with the event.

In an embodiment, one or more of the content model strategies may be considered at once to rank and select queries that generate a good match to the event information according to one or more of temporal, spatial and topical models.

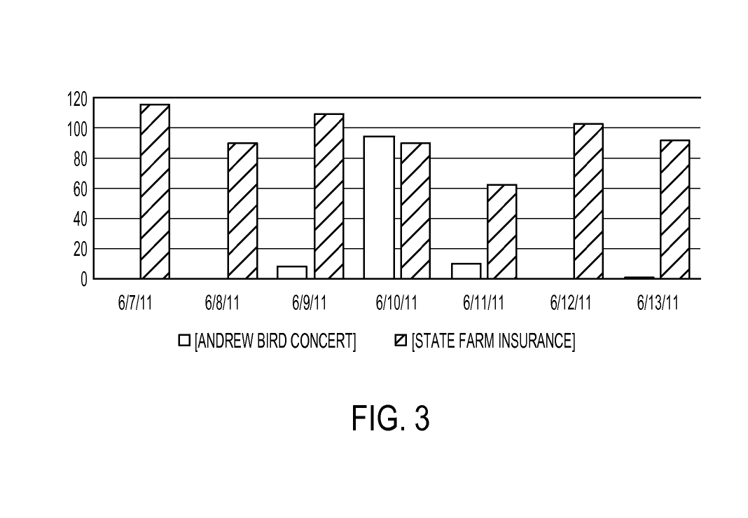

For example, FIG. 3 illustrates an example media document volume histogram over media content site documents for two recall-oriented queries retrieved around the week of Andrew Bird's concert at “Celebrate Brooklyn!” according to an embodiment. As illustrated by FIG. 3, the volume of a general query such as [state farm insurance] is consistent over time, whereas the volume of the query [andrew bird concert] increases around the time of the event.

In an embodiment, each of these query selection strategies, such as specificity and different ways to perform a model profile match, may be used individually to identify relevant queries for an event. In an embodiment, a plurality of the selection strategies may be combined to identify relevant queries for an event. These queries may be used to retrieve associated media documents from a variety of media content sites. Content retrieved from the various sites may generate complementary signals for the recall-oriented query generation and retrieval process.

Different techniques will vary on how subsets are selected. In an embodiment, one or more of the following query ranking methods may be used to rank queries. In an embodiment, top N queries according to a ranking methods may be selected and used.
MS n-gram Score (MS): n-gram score of the query from the Microsoft Web n-gram Service;
Time Ratio (TR): ratio of the number of documents created in the 48 hours before and after the event to the number of documents created in the week before and after the event;
Restricted Time Ratio (RTR): ratio of the number of documents created in the 24 hours before and after the event to the number of documents created in the week before and after the event;
MS n-gram Score and Time Ratio (MS-TR): MS score multiplied by TR score;
MS n-gram Score and Restricted Time Ratio (MS-RTR): MS score multiplied by RTR score.

### Leveraging Cross-Site Content

Querying for event content from multiple media content sites may provide a holistic perspective on an event, and may result in obtaining content, such as digital media for example, from a variety of user perspectives. For the “Celebrate Brooklyn!” opening concert, for instance, different media content sites may be used to learn about the event (e.g., via a Twitter message “Celebrate Brooklyn kicks off TONIGHT with Andrew Bird concert in Prospect Park!”), watch a video of a song performed at the event (e.g., “Andrew Bird—Effigy (Live)—Prospect Park—Brooklyn, N.Y.” on YouTube), and/or see up-close photos of Andrew Bird on stage during the event (e.g., “Andrew Bird: Prospect Park Bandshell” photo set on Flickr).

In an embodiment, event content from one media content site may be leveraged to help retrieve event documents from another media content site. For example, event content from one media content site may be used to help retrieve event documents from another media content site according to one or more of the query generation strategies discussed above. In an embodiment, one or more recall-oriented queries may be generated for each site individually and these queries may be used across multiple sites. Specifically, the high-precision results obtained from an individual site may be used to formulate one or more recall-oriented queries as described above. These site-specific recall-oriented queries may be used to obtain additional results from other media content sites. This may be especially useful when the precision-oriented strategies do not retrieve results from all sites. For instance, referring to the “Celebrate Brooklyn!” example, because the event title is specific, the precision-oriented queries may fail to retrieve any documents from certain media content sites, such as, for example, YouTube. As such, recall-oriented queries may not be generated for these sites. In an embodiment, other media content sites, such as Twitter for example, may provide a wealth of results for the precision-oriented queries for an event, and the resulting recall-oriented queries (e.g., [andrew bird concert], [brooklyn celebrate]) may be used to retrieve relevant videos from other media content sites, such as YouTube. In an embodiment, the system may extract useful YouTube (or other media content site) content through queries derived based on Twitter content (or another media content site's content).

In an embodiment, one or more recall-oriented queries may be generated using high-precision results returned from all media content sites collectively. Obtaining precision-oriented results from multiple sites may yield a larger “ground-truth” corpus for the recall-oriented query generation than the ones obtained from each site individually. A larger “ground-truth” corpus may be helpful for identifying salient event terms that appear frequently across sites. This approach may also include a step to remove noise or irrelevant content that is often present in some sites and not others (e.g., Twitter username mentions or other site-specific features).

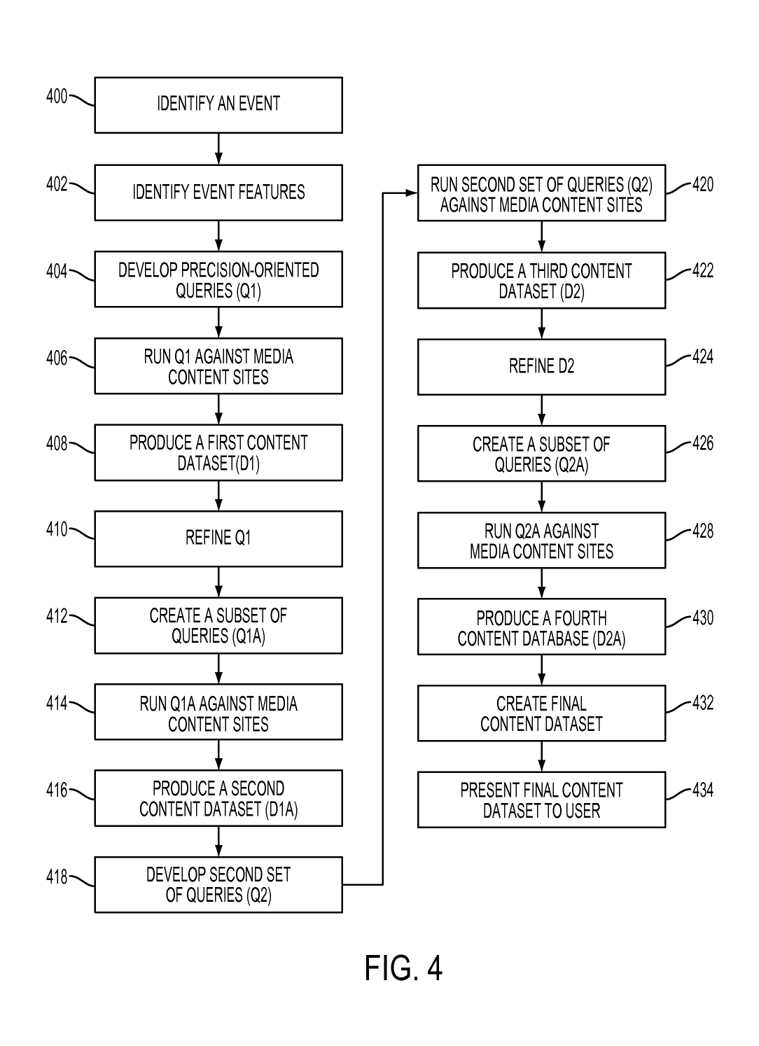

FIG. 4 illustrates a flow chart of an example method of retrieving content associated with an event from one or media content sites according to an embodiment. As illustrated by FIG. 4, an event may be identified 400. The event may be a planned event or an unplanned event. An event may be identified 400 by a system user, such as a website administrator or editor, by providing details pertaining to the event, such as, for example, the name of the event, a date of the event, a location of the event and/or the like.

In an embodiment, one or more event features associated with the identified event may be identified 402. An event feature may be provided by a system user according to an embodiment. An event feature may be identified 402 from one or more event aggregation platforms, websites, media content sites and/or the like.

In an embodiment, one or more precision-oriented queries (Q1) for an event may be developed 404 using one or more of the identified event features. The queries (Q1) may be run 406 against data or APIs of one or more media content sites to produce 408 a first content dataset (D1). In an embodiment, the first content dataset (D1) may include content from the one or more media content sites that satisfy the precision-oriented queries (Q1).

In an embodiment, the precision-oriented queries (Q1) may be refined 410 to create 412 a subset of queries (Q1A) from the precision-oriented queries (Q1). The subset of queries (Q1A) may include and/or prioritize queries from the precision-oriented queries (Q1) for which a model of the set of results matches the known information about the event. In an embodiment, the model may be based on temporal, spatial, topical or other features. In an embodiment, a parameter may be an anticipated or expected parameter associated with an event such as, for example, a time or time period associated with the event.

In an embodiment, the queries in the subset (Q1A) may be run 414 against data or APIs of one or more media content sites to produce 416 a second content dataset (D1A). In an embodiment, a second set of queries (Q2) may be developed 418 for the event based, at least in part, on the contents of dataset D1 and/or D1A. The second set of queries (Q2) may be run 420 against data or APIs of one or more media content sites to produce 422 a third content dataset (D2). The third dataset (D2) may be refined 424 to create 426 a subset of queries (Q2A) from the second set of queries (Q2). The subset of queries (Q2A) may include and/or prioritize queries from the second set of queries (Q2) whose set of results matches one or more parameters associated with the event. In an embodiment, the queries in the subset (Q2A) may be run 428 against data or APIs of one or more media content sites to produce 430 a fourth content dataset (D2A).

In an embodiment, D1, D1A, D2 and/or D2A may be combined to create 432 a final content dataset(s) that correspond to the event (D). At least a portion of the final content dataset (S) may be presented 434 to a system user. For example, at least a portion of the content within the final content dataset (S) may be displayed to a user at a computing device. In an embodiment, a summary of a dataset and/or one or more statistics relating to a dataset may be presented 434 to a user. In an embodiment, certain steps 400-434 of the method illustrated by FIG. 4 may be optional. In an embodiment, one or more steps 400-434 of the method illustrated by FIG. 4 may be performed in one or more combinations. For example, in an embodiment, only steps 400-408 may be performed. In another embodiment, only steps 400-416 may be performed. Additional and/or alternate combinations may be performed within the scope of this disclosure.

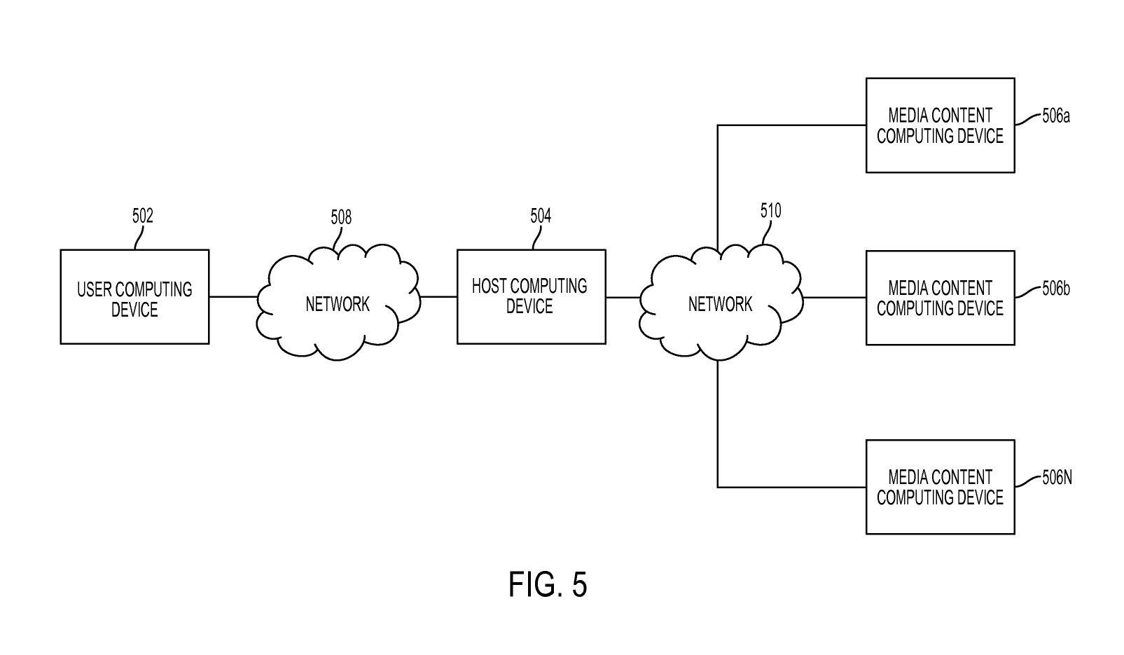

FIG. 5 illustrates an example system of retrieving content associated with an event from one or more media content sites according to an embodiment. As illustrated by FIG. 5, the system 500 may include a user computing device 502, a host computing device 504 and one or more media content computing devices 506a-N.

In an embodiment, a “computing device” may refer to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

A user computing device 502 may be a computing device associated with a user requesting content from one or more media content sites. In an embodiment, a user computing device 502 may be a computing device on which retrieved content may be displayed.

A user computing device 502 may be in communication with a host communication via a communications network 508. In various embodiments, the communication network 508 may be a local area network (LAN), a wide area network (WAN), a mobile or cellular communication network, an extranet, an intranet, the Internet and/or the like. In an embodiment, the communication network 508 may provide communication capability between a user computing device 502 and a host computing device 504. Although FIG. 5 illustrates one user computing device 502 and one host computing device 504, it is understood that the system 500 may include more than one user computing device and/or host computing device within the scope of this disclosure. In an embodiment, a user computing device 502, a host computing device 504 and/or a media content computing device 506 may be a set of computing devices, such as, for example, a set of servers.

In an embodiment, a host computing device 504 may identify content from one or more media content sites. A host computing device may be in communication with one or more media content computing devices 506a-N via a communication network 510. In various embodiments, the communication network 510 may be a local area network (LAN), a wide area network (WAN), a mobile or cellular communication network, an extranet, an intranet, the Internet and/or the like. In an embodiment, the communication network 510 may provide communication capability between a host computing device 504 and one or more media content computing devices 506a-N.

In an embodiment, a media content computing device 506a-N may be a computing device associated with a media content site and/or service. For example, a media content computing device 506a-N may be a server on which a media content site is hosted.

In an embodiment, the system will automatically retrieve content for events available from an event information system, such as, for example, EventBrite. In an embodiment, the content will be retrieved only for popular events which many people indicated they will or have attended. In an embodiment, a user/editor may choose which events for which the system should retrieve content.

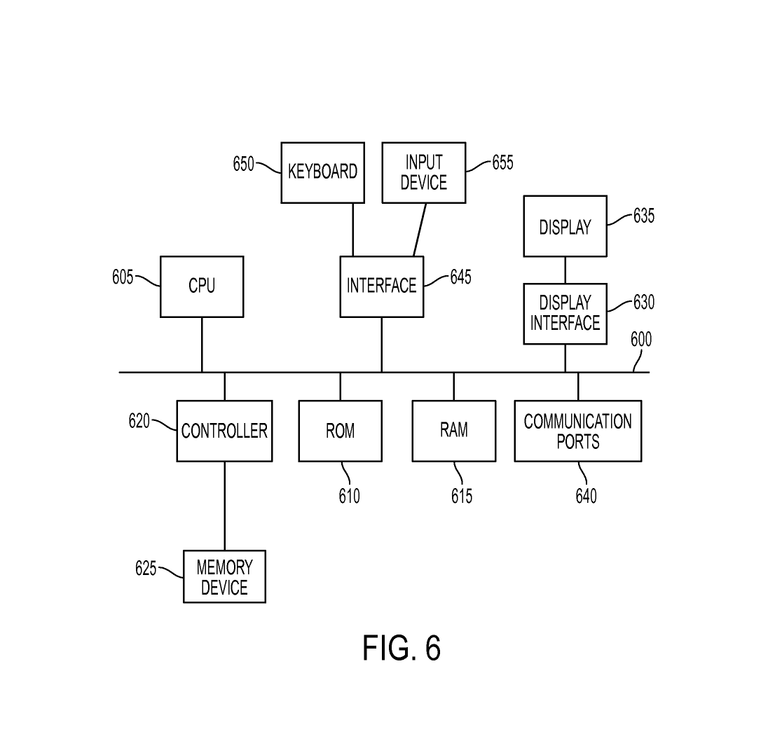

FIG. 6 depicts a block diagram of hardware that may be used to contain or implement program instructions. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an example of a production device, computing device or processor as such terms are used within this disclosure. Read only memory (ROM) 610 and random access memory (RAM) 615 constitute examples of non-transitory computer-readable storage media.

A controller 620 interfaces with one or more optional non-transitory computer-readable storage media 625 to the system bus 600. These storage media 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 630 may permit information from the bus 600 to be displayed on the display 635 in audio, visual, graphic or alphanumeric format. Communication with external devices, such as a printing device, may occur using various communication ports 640. A communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of retrieving content from one or more media content sites, the method comprising:
identifying one or more event features corresponding to an event;
automatically generating, by a computing device, a first set of one or more queries based on the identified event features;
running, by the computing device, at least a portion of the first set of queries against one or more media content sites to generate a first content dataset comprising one or more media documents that satisfy the queries;
creating a query model for each query based on one or more results retrieved for the query in the first content dataset;
evaluating each query model against one or more of the identified event features to identify a match; and
performing one or more of the following:
filtering the queries based on their associated match, and
ranking the queries based on their associated match.

2. The method of claim 1, wherein the one or more event features comprise one or more of the following:
at least a portion of an event title;
an event location;
an event venue;
an event date;
an event time;
one or more users associated with the event;
metadata associated with the event; and
a description of the event.

3. The method of claim 1, wherein evaluating each query model comprises evaluating each query model using one or more of the following:
a temporal model match to a time period associated with the event;
a spatial model match to a location associated with the event; and
a topic model match to a set of phrases, topics, and/or topic models associated with the event.

4. The method of claim 1, further comprising running, by the computing device, a subset of the queries against a second set of one or more media content sites to produce a second content dataset of media documents.

5. The method of claim 4, further comprising:
creating a second set of queries based on the second content dataset; and
running the second set of queries against a third set of one or more media content sites to produce a third content dataset of media documents.

6. The method of claim 5, wherein creating the second set of queries is based on one or more of the following:
a location of one or more media documents in the second content dataset;
a language of one or more media documents in the second content dataset;
one or more phrases appearing in one or more media documents in the second content dataset;
one or more users posting one or more media documents in the second content dataset;
statistical analysis of one or more words appearing in the second content dataset;
a time associated with one or more media documents in the second content dataset; and
metadata associated with one or more media documents in the second content dataset.

7. The method of claim 5, further comprising:
creating a final content dataset by combining one or more of the first content dataset, the second content dataset and the third content dataset.

8. The method of claim 5, further comprising:
creating a second query model for each query in the second set of queries based on the second content dataset; and
evaluating each second query model against one or more of the identified event features to identify a second match;
performing one or more of the following:
filtering the queries in the second set of queries based on their associated second match, and
ranking the queries in the second set of queries based on their associated second match; and
running, by the computing device, a subset of the second queries against a fourth set of one or more media content sites to produce a fourth content dataset.

9. The method of claim 8, wherein evaluating each second query model comprises evaluating each second query model using one or more of the following:
a temporal model match to a time period associated with the event;
a spatial model match to a location associated with the event; and
a topic model match to a set of phrases, topics, and/or topic models associated with the event.

10. A system for retrieving content from one or more social media sites, the system comprising:
a computing device; and
a computer-readable storage medium in communication with the computing device, wherein the computer-readable storage medium comprises one or more programming instructions that, when executed, cause the computing device to:
identify one or more event features corresponding to an event,
develop a first set of one or more precision-oriented queries based on the identified event features,
run the first set of precision-oriented queries against a first set of one or more media content sites to produce a first content dataset that comprises content from the first set of media content sites that satisfies the first set of precision-oriented queries, and
refine the first set of precision-oriented queries to create a first subset of precision-oriented queries that comprises one or more precision-oriented queries whose results satisfy one or more parameters associated with the event.

11. The system of claim 10, wherein the computer-readable storage medium further comprises one or more programming instructions that, when executed, cause the computing device to:
run the first subset of precision-oriented queries against a second set of one or more media content sites to produce a second content dataset that comprises content from the second set of media content sites that satisfies the first subset of precision-oriented queries.

12. The method of claim 11, wherein the computer-readable storage medium further comprises one or more programming instructions that, when executed, cause the computing device to create a final content dataset by combining the first content dataset and the second content dataset.

13. The system of claim 10, wherein the computer-readable storage medium further comprises one or more programming instructions that, when executed, cause the computing device to:
develop a second set of queries for the event based, at least in part, on the first content dataset; and
run the second set of queries against a second set of one or more media content sites to produce a second content dataset that comprises content from the second set of media content sites that satisfies the second set of queries.

14. The system of claim 13, wherein the computer-readable storage medium further comprises one or more programming instructions that, when executed, cause the computing device to create a final content dataset by combining the first content dataset and the second content dataset.

15. The system of claim 13, wherein the computer-readable storage medium further comprises one or more programming instructions that, when executed, cause the computing device to:
refine the second set of queries to create a second subset of queries that comprise one or more queries whose results satisfy one or more parameters associated with the event; and
run the second subset of queries against a third set of media content sites to produce a third content dataset that comprises content from the third set of media content sites that satisfies the second subset of queries.

16. The system of claim 15, wherein the computer-readable storage medium further comprises one or more programming instructions that, when executed cause the computing device to create a final content dataset by combining the first content dataset, the second content dataset and the third content dataset.

17. The system of claim 11, wherein the computer-readable storage medium further comprises one or more programming instructions that, when executed, cause the computing device to:
develop a second set of queries for the event based, at least in part, on one or more of the first content dataset and the second content dataset; and
run the second set of queries against a third set of one or more media content sites to produce a third content dataset that comprises content from the third set of media content sites that satisfies the second set of queries.

18. The system of claim 17, wherein the computer-readable storage medium further comprises one or more programming instructions that, when executed, cause the computing device to:
refine the second set of queries to create a second subset of queries that comprise one or more queries whose results satisfy one or more parameters associated with the event; and
run the second subset of queries against a fourth set of media content sites to produce a fourth content dataset that comprises content from the fourth set of media content sites that satisfies the second subset of queries.

19. The system of claim 18, wherein the computer-readable storage medium further comprises one or more programming instructions that, when executed, cause the computing device to create a final content dataset by combining the first content dataset, the second content dataset, the third content dataset and the fourth content dataset.
